(19) United States
(12) Patent Application Publication
(10) Pub. No.: US 2017/0330225 A1
(43) Pub. Date: Nov. 16, 2017

(54) COMMUNICATION CONTENT

(71) Applicants: Ronald Charles Krosky, Lakewood, OH (US); Brendan Edward Clark, Rocky River, OH (US)

(72) Inventors: Ronald Charles Krosky, Lakewood, OH (US); Brendan Edward Clark, Rocky River, OH (US)

(21) Appl. No.: 12/692,599

(22) Filed: Jan. 23, 2010

Related U.S. Application Data
(60) Provisional application No. 61/147,070, filed on Jan. 23, 2009.

(51) Int. Cl. G06Q 30/02; H04L 12/58

(52) U.S. Cl. CPC G06Q 30/0251; H04L 51/02

(57) ABSTRACT

Systems, methods, and other embodiments associated with communication content are described. According to one embodiment, a system comprises an identification component to identify a communication. In addition, the system comprises an integration component to integrate a content on a dynamic portion of the communication. In this embodiment, selection of the content is based, at least in part, on a set of recipients. Also in this embodiment, the content is harmonious with the communication.

### CROSS REFERENCE TO RELATED APPLICATIONS

This application claims the benefit of U.S. provisional application Ser. No. 61/147,070 filed on Jan. 23, 2009, which is hereby wholly incorporated by reference.

### BACKGROUND

A communication can include a content that is disclosed to a user. For example, the communication can be a wired or wireless signal and the content can be a television program. The television program may be displayed to the user by way of a television set, or various other devices. In a case with the television set, a program can serve a variety of different functions, including entertaining the user, informing the user, and others. Thus, a wired or wireless signal can carry a television program serving one or more such functions into a home of a user or other locations.

### BRIEF DESCRIPTION OF THE FIGURES

The accompanying drawings, which are incorporated in and constitute a part of the detailed description, illustrate various example systems, methods, and other example embodiments of various innovative aspects. These drawings include:

FIG. 1 that illustrates one embodiment of a system with an integration component and an identification component,

FIG. 2 that illustrates one embodiment of a communication network,

FIG. 3 that illustrates one embodiment of a pre-integration scene and a post-integration scene,

FIG. 4 that illustrates one embodiment of a pre-integration scene and a post-integration scene,

FIG. 5 that illustrates one embodiment of a pre-integration scene and a post-integration scene,

FIG. 6 that illustrates one embodiment of a pre-integration scene and a post-integration scene,

FIG. 7 that illustrates one embodiment of a pre-integration communication and a post-integration communication,

FIG. 8 that illustrates one embodiment of a pre-integration communication and a post-integration communication,

FIG. 9 that illustrates one embodiment of a communication with a first view type and a second view type,

FIG. 10 that illustrates one embodiment of a system with a selection component,

FIG. 11 that illustrates one embodiment of a system with an evaluation component 1105 and a recognition component,

FIG. 12 that illustrates one embodiment of a system with a calculation component,

FIG. 13 that illustrates one embodiment of a system with a resolution component,

FIG. 14 that illustrates one embodiment of a system with a first device component and a second device component,

FIG. 15 that illustrates one embodiment of a system with a choice component,

FIG. 16 that illustrates a system with a first device evaluation component, a second device evaluation component, and a construction component,

FIG. 17 that illustrates one embodiment of a system with a first advertisement evaluation component and an advertisement selection component,

FIG. 18 that illustrates one embodiment of a system with first advertisement analysis component and a second device selection component,

FIG. 19 that illustrates one embodiment of a system that includes an identification component and an integration component,

FIG. 20 that illustrates one embodiment of a method for causing communication display,

FIG. 21 that illustrates one embodiment of a method for causing communication display,

FIG. 22 that illustrates one embodiment of a method for causing communication display,

FIG. 23 that illustrates one embodiment of an example system that can be used in practice of at least one innovative aspect disclosed herein, and

FIG. 24 that illustrates one embodiment of an example system that can be used in practice of at least one innovative aspect disclosed herein.

It will be appreciated that illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale. These elements and other variations are considered to be embraced by the general theme of the figures, and it is understood that the drawings are intended to convey the spirit of certain features related to this application, and are by no means regarded as exhaustive or fully inclusive in their representations.

The terms ‘may’ and ‘can’ are used to indicate a permitted feature, or alternative embodiments, depending on the context of the description of the feature or embodiments. In one example, a sentence states ‘A can be AA’ or ‘A may be AA’. Thus, in the former case, in one embodiment A is AA, and in another embodiment A is not AA. In the latter case, A may be selected to be AA, or A may be selected not to be AA. However, this is an example of A, and A should not be construed as only being AA. In either case, however, the alternative or permitted embodiments in the written description are not to be construed as injecting ambiguity into the appended claims. Where claim ‘x’ recites A is AA, for instance, then A is not to be construed as being other than AA for purposes of claim x. This is construction is so despite any permitted or alternative features and embodiments described in the written description.

### DETAILED DESCRIPTION

Described herein are example systems, methods, and other embodiments associated with communication content. An example communication may be a wireless signal. The wireless signal may include data for a television program and the communication may be the television program. In one example, the television program is a television drama. The television drama can be filled with content. Example content includes scenes, individual shots, and advertisements. This content can be made up of different elements (e.g., aspects of a scene, part of a scene, and others). An example element may be a beverage can. The element can be represented or exist within one or more scenes in many different ways. For example, one scene may include a beverage can that can be seen, noises associated with the beverage can, interactions with the can, and dialogue among characters discussing the beverage can, and others.

The beverage can may include a logo or specific branding. The beverage can may be customized to a viewer set of the television drama. For example, viewers in Atlanta can see a Coca-Cola can while views in St. Louis see a Bud Light can. This allows for the beverage can to be customizable to the St. Louis views and Atlanta viewers. This customization can occur at various points along a distribution chain for the television drama. In one example, a local cable box is aware of viewers to a particular television set. If no viewer is under 21 years-old then a Bud Light can is shown. If a viewer is under 21 years-old, then a Coca-Cola can is shown. Thus, content of the communication can be customized to a viewer set.

It is to be appreciated that different content can be integrated into one communication at various eventual locations and/or devices where a viewer can receive the communication. This integration can invoke concepts as broad as wide-scale geography (e.g. Atlanta and St. Louis as discussed above), as specific as devices located in a single room, and others concepts in-between.

The following is an example of different integration aspects being performed for one communication. A family in Atlanta could view a different integrated content than a family in Saint Louis while receiving the same communication and viewing the same scene. Within one of those families, children in one room could receive integrated content directed to children, and adults in another room receive integrated content directed to an older audience. Within one of the rooms, still another different integrated content could appear on an individual's mobile device, the content directed to that individual, while the mobile device displays the same communication. This can occur during one communication (e.g. TV show being watched by many people in many locations on many devices). In one example, the content can be directed to one product, a group of product, unrelated products, and others. While the above refers to any one device as “receiving” integrated content, the use of this terminology is intended in a non-limiting way and generally describes transmission, integration and display of content in the communication.

The following paragraphs include definitions of selected terms discussed at least in the detailed description. The definitions may include examples used to explain features of terms and are not intended to be limiting. In addition, where a singular term is disclosed, it is to be appreciated that plural terms are also covered by the definitions. Conversely, where a plural term is disclosed, it is to be appreciated that a singular term is also covered by the definition.

References to “one embodiment”, “an embodiment”, “one example”, “an example”, and so on, indicate that the embodiment(s) or example(s) so described may include a particular feature. The embodiment(s) or example(s) are shown to highlight one feature and no inference should be drawn that every embodiment necessarily includes that feature. Multiple usage of the phrase “in one embodiment” and others does not necessarily refer to the same embodiment; however this term may refer to the same embodiment. It is to be appreciated that multiple examples and/or embodiments may be combined together to form another embodiment.

“Computer-readable medium”, as used herein, refers to a medium that stores signals, instructions and/or data. A computer may access a computer-readable medium and read information stored on the computer-readable medium. In one embodiment, the computer-readable medium stores instruction and the computer can perform those instructions as a method. The computer-readable medium may take forms, including, but not limited to, non-volatile media (e.g., optical disks, magnetic disks, and so on), and volatile media (e.g., semiconductor memories, dynamic memory, and so on). Example forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, and other media from which a computer, a processor or other electronic device can read.

“Component”, “logic”, “module”, “interface” and the like as used herein, includes but is not limited to hardware, firmware, software stored or in execution on a machine, a routine, a data structure, and/or at least one combination of these (e.g., hardware and software stored). Component, logic, module, and interface may be used interchangeably. A component may be used to perform a function(s) or an action(s), and/or to cause a function or action from another component, method, and/or system. A component may include a software controlled microprocessor, a discrete logic (e.g., ASIC), an analog circuit, a digital circuit, a programmed logic device, a memory device containing instructions, a process running on a processor, a processor, an object, an executable, a thread of execution, a program, a computer and so on. A component may include one or more gates, combinations of gates, or other circuit components. Where multiple components are described, it may be possible to incorporate the multiple components into one physical component. Similarly, where a single component is described, it may be possible to distribute that single component between multiple physical components. In one embodiment, the multiple physical components are distributed among a network. By way of illustration, both/either a controller and/or an application running on a controller can be one or more components.

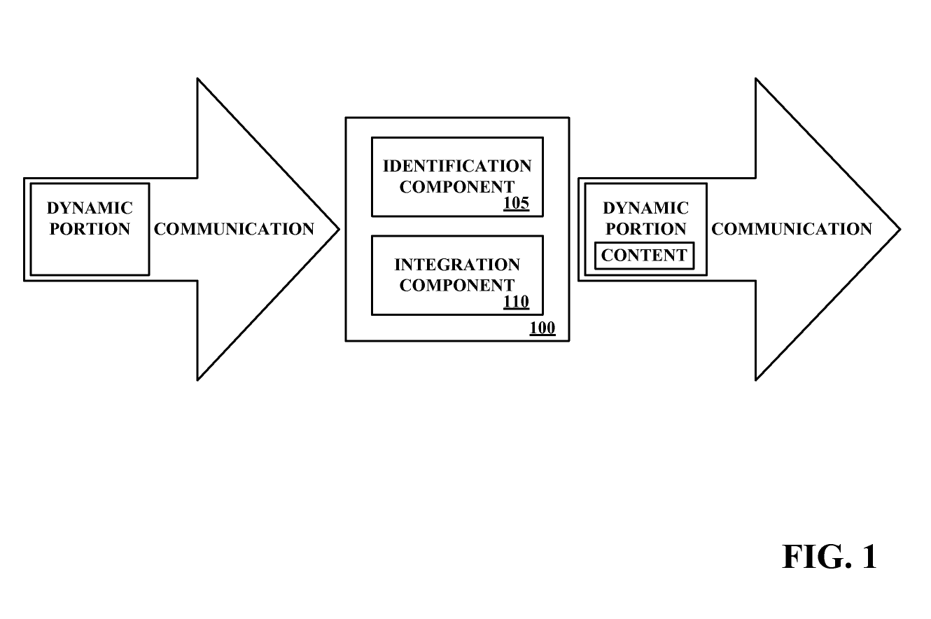

FIG. 1 illustrates one embodiment of a system 100 with an integration component 105 and an identification component 110. The identification component 105 can identify a communication. Example communications include a television program, streamed internet content, a billboard, a movie, and various other forms. The identification component 105 can perform active monitoring or passive monitoring in identifying the communication. In one example, active monitoring can be seeking out signals and determining if the signal is a communication (e.g., a media content communication). In one example, passive monitoring can be the identification component 110 identifying the communication in response to receiving an instruction to identify the communication. In one embodiment, upon receiving a signal, the identification component analyzes the signal to determine if the signal is a communication for purposes of the system 100. In one embodiment, the identification component 105 identifies the dynamic portion of the communication.

The integration component 110 can integrate a content on the dynamic portion of the communication. In one embodiment, a scene of the communication includes an element set aside to be integrated with content. In this embodiment, the element is the dynamic portion. In one example, the element is a blue screen area. The integration component 110 can cause a specific element to be placed over the blue screen area. In one example, the specific element is a Coca-cola can. When the element is displayed, the element is displayed as the specific element and not the blue screen element.

It is to be appreciated that blue screen and similar terms used herein are used to describe chroma keying and is not intended to limit practice to an actual blue screen. In one example, a green screen may be used. In one example, a different chroma keying technique other than using a color screen may be used.

Employing blue screen technology illustrates one example of realizing the integration component 110. In other embodiments, the dynamic portion and/or element are not blue screen areas, and the integration component 110 integrates content onto a dynamic portion that is identified on-the-fly, or is designated for integration by means other than blue screen technology.

In one embodiment, the integration component 110 integrates the content on a dynamic portion not intended to be modified. For example, an element of the scene can be a Coca-Cola beverage can. The integration component can cause a Pepsi-Cola beverage can to replace the Coca-Cola beverage can. The Pepsi-Cola can may be the content while the Coca-Cola can is the dynamic portion.

Selection of the content can be based, at least in part, on a set of recipients (e.g., one or more recipients). In one example, specific individuals viewing or anticipated to view the communication can be evaluated based on age, race, gender, sexual orientation, viewing history, personal preferences, career, income, recent purchases and/or other demographic or personal characteristics. A result from this evaluation can be used in selecting the content. In one example, an artificial intelligence component can be used to determine content to select.

The integrated content can be harmonious with the communication. Being harmonious can include that a viewer is not aware that content integration occurs. Being harmonious can include that the content is thematic with the communication. In one example, if elements of one scene are soda cans, then the content may also be a soda can. The content can also be evaluated to ensure its appropriateness, (e.g., that content “makes sense” in a scene). In one example, if a scene takes place in the 1800s, the content might not be a video game system since the video game system is not appropriate. However, for companies that have a longer brand life, an earlier product could be displayed to accommodate the period piece. In one example, a piece for the 1930s can have a Coca-cola glass bottle integrated onto a scene as opposed to an aluminum can. Processes can be arranged to ensure dynamic portions are filled even if the intended element or aspect is found to be inappropriate (e.g., inappropriate content is selected over a blue screen being presented). However, context alone can be dispositive to a factor of harmoniousness. In one embodiment, a harmonious integration can appear seamless within the scene, such that a viewer would believe the integrated content had been presented in the observed fashion at the time of communication production.

While the dynamic portion and content are discussed in relation to a scene element, it is to be appreciated that other embodiments can be practiced. In one example, the dynamic portion is a 30-second commercial break. With this dynamic portion, the content can be a 30-second commercial inserted into the break or that replaced another 30-second commercial.

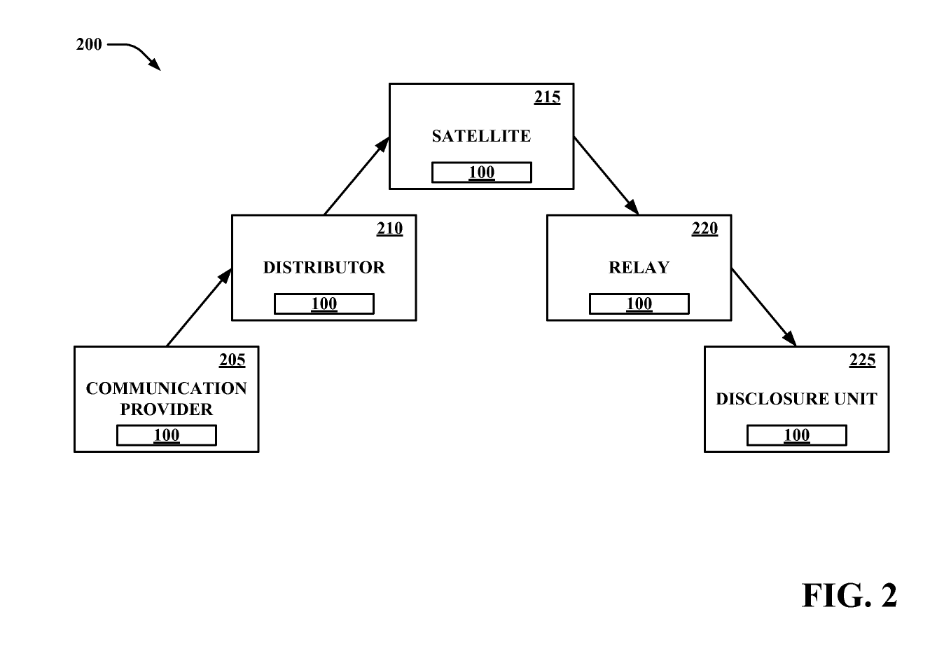

FIG. 2 illustrates one embodiment of a communication network 200. A communication can travel along the communication network 200. The communication network 200 includes a communication provider 205, distributor 210, satellite 215, relay 220, and a disclosure unit 225. The communication provider 205 can collect the communication from a content originator (e.g., an entity that produces the communication). In one embodiment, the communication provider 205 includes the content originator.

The distributor 210 collects the communication from the communication provider 205. The distributor 210 can include a logic that determines where the communication should be sent. Based on a determination made by the logic, the communication can be sent to the satellite 215 that transfers the communication to a disclosure unit 225. In one embodiment, the relay 220 is employed to transfer the communication to the disclosure unit 225. The disclosure unit 225 can include a cable box, a media player, a television (e.g., standard definition, high definition, capable of displaying three-dimensional content, and others), a computer screen, a cellular telephone, a personal digital assistant, a wireless router, and others.

The components of various systems can be located or operate in one or more physical or logical places along the path between a producer of a communication and the eventual set of recipients. In one embodiment, the integration component 110 of FIG. 1 functions, at least in part, local to the set of recipients (e.g., the integration component 110 of FIG. 1 functions at the disclosure unit 225). In one embodiment, 1, the integration component 110 of FIG. 1 functions, at least in part, local to a distributor of the communication (e.g., the distributor 210). In one embodiment, the communication provider 205, the satellite 215, the relay 220, or a combination thereof integrates as part of the distributor 210. In one embodiment, the integration component 110 of FIG. 1 functions, at least in part, local to a producer of the communication (e.g., the communication provider 205). In one embodiment, the system 100 (e.g., the whole system 100, at least one component of the system 100, and others) is located on a communication provider 205, distributor 210, satellite 215, relay 220, a disclosure unit 225, or a combination thereof. In one example, the integration component 110 is distributed across the content provider and distributor.

While the communication network 200 is depicted as including five units, it is to be appreciated that the communication network 200 can function with more or less units. In one example, the communication network 200 functions without the relay 220. In one example, the communication network 200 functions with a separate content provider. In addition, while this specific communication network is shown, it is to be appreciated that the system 100 can function independent of a communication network 200. In one example, the system 100 resides on a personal computer and the communication is displayed on a monitor of the personal computer.

In one embodiment, a content is integrated (e.g., by the integration component 110 of FIG. 1) on the dynamic portion of the communication after creation of the communication. In one embodiment, the content is integrated at a communication creator, but after creation occurs. In one embodiment, the content is integrated at the disclosure unit 225. In one embodiment, the system 200 uses Tru2way and/or OpenCable technology. In one embodiment, aspects disclosed herein function in conjunction with Enhanced TV Binary Interchange Format (EBIF) specification (e.g., version IO5). These are merely examples of possible embodiments, and not intended to exclude alternatives.

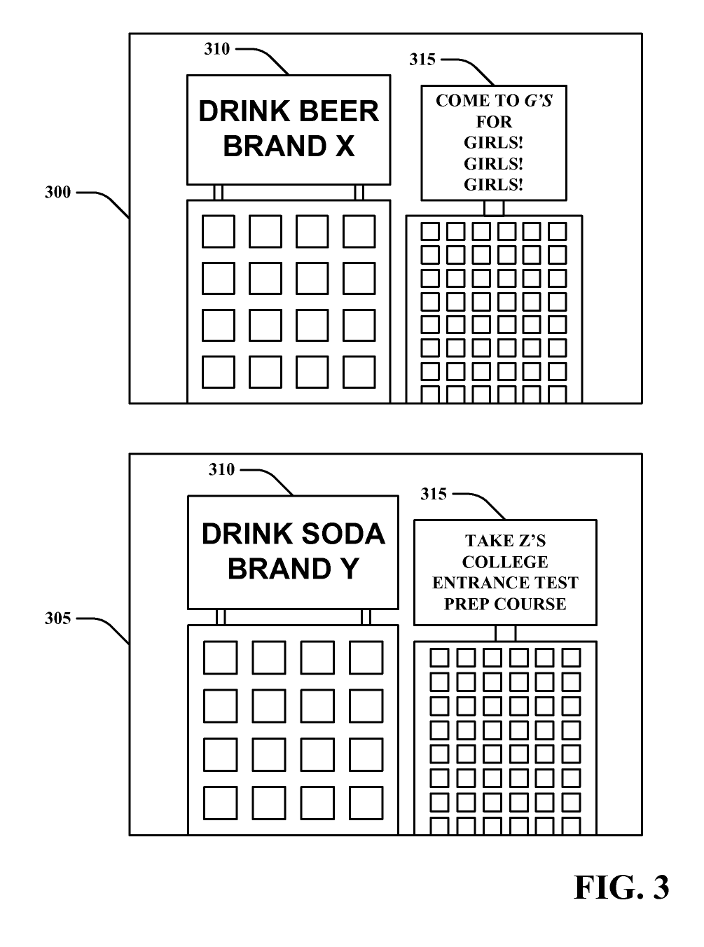

FIG. 3 illustrates one embodiment of a pre-integration scene 300 and a post-integration scene 305. The pre-integration scene 300 may be found in a communication after being originally produced by a content provider. The post-integration scene 305 may be found in the communication after the system 100 of FIG. 1 functions upon the communication.

In one example, the pre-integration scene 300 is a scene depicting a first building with a first sign 310 and a second building with a second sign 315. The first sign 310 advertises beer while the second sign 315 advertises an adult entertainment establishment. A viewer set (e.g., a recipient set that views content) with parents and children may find content of the first sign 310 and the second sign 315 objectionable.

Therefore, the system 100 of FIG. 1 can operate on the pre-integration scene 300 to make the scene less objectionable. The viewer set can be analyzed to determine replacement content that the viewer set would find less objectionable. The viewer set can also be analyzed to determine what content the viewer set would likely find objectionable. Analysis can occur on a viewing history profile retained over previous viewing sessions. The integration component can suppress the first sign 310 and second sign 315. Suppression can occur by way of deleting data portions for the first sign 310 and second sign 315 or masking data portions for the first sign 310 and second sign 315. Alternatively, or simultaneously, new data portions can replace, mask, obscure, or otherwise alter the objectionable content to satisfaction of the viewer set. In at least one instance, several elements of a scene can be designated or identified as dynamic portions, in order to allow finer control over content that may or may not be objectionable to certain audiences.

In one example, objectionable content may be permissible for one element (e.g., by a parent of a child in the viewer set), but not more than one. The system 100 of FIG. 1 can select which element to make objectionable and select other content that is not objectionable for integration on other elements.

The first sign 310 and second sign 315 can be considered dynamic portions of the communication (e.g., a scene of the communication). The integration component 110 of FIG. 1 causes the content of the first sign 310 and second sign 315 to change in the post-integration scene 305. The content change can be based on the viewer set. In one example, the viewer set can be a high school student. With a high school student, it may be ill-advised to advertise a beer and adult entertainment establishment. Therefore, a beer advertisement on the first sign 305 can be replaced by a soda advertisement or other age-appropriate content.

Context of the viewer set can be taken into account when selecting and integrating content. In one example, the high school student can be preparing for a college entrance test. An advertisement can be selected for the second sign 310 that advertises a college entrance test prep course. Thus, selected replacement content can be age-appropriate as well as something of particular interest to a user and/or something a user might want to see. With the first sign 305 and second sign 310 being background signs in the scene, these replacements can be considered harmonious with the communication.

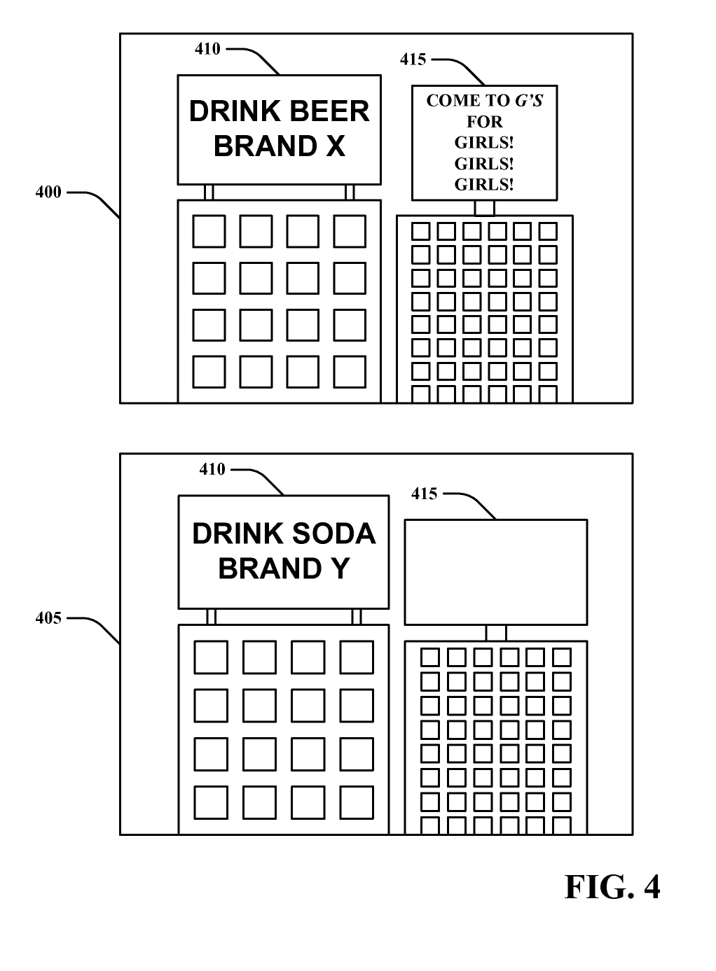

FIG. 4 illustrates one embodiment of a pre-integration scene 400 and a post-integration scene 405. The pre-integration scene 400 can include a first sign 410 and a second sign 410. The pre-integration scene 400 can include matching content to the pre-integration scene 300 of FIG. 3. In the post-integration scene 405, the first sign 415 can be replaced with content the same as the first sign 315 in FIG. 1 as shown in the post-integration scene 305 of FIG. 3.

In the post-integration scene 405, a comparable replacement can be found. In one example, a viewer set includes a viewer that is sixteen years-old. A soda advertisement can be the comparable replacement for a beer advertisement. Thus, the integration component 110 of FIG. 1 can replaced the beer advertisement for the first sign 415 with a soda advertisement. This replacement is shown in comparison between the pre-integration scene 400 and the post integration scene 405.

However, an adult entertainment establishment may not have an available comparable replacement. In one example, the system 100 of FIG. 1 uses a local data library to store content. An algorithm can be used to select content from the local data library for integration on a dynamic portion. The algorithm can function to identify a comparable replacement. Without a comparable replacement, blank content can be selected. Thus, the integration component 110 of FIG. 1 integrates blank content on the dynamic portion. Blank content integration is shown in comparison between the second sign 420 in the pre-integration scene 400 and the second sign 420 in the post integration scene 405. Blank content integration can include deleting a part of the dynamic portion, masking the part of the dynamic portion, or integrating content to produce a replacement sign. In one embodiment, the second sign 420 is deleted from the post-integration scene and a sky background is integrated in place of the second sign 420. In one embodiment, a generic replacement can be used from the library in order to avoid disrupting the communication. Generic content can be one or more “stock” elements used to fill in dynamic portions that would otherwise be blank or be appropriate for replacement. Generic content can take a diverse range of forms and varieties, and can originate from local and/or remote sources, and/or be fetched on-the-fly via one or more networks or other connections.

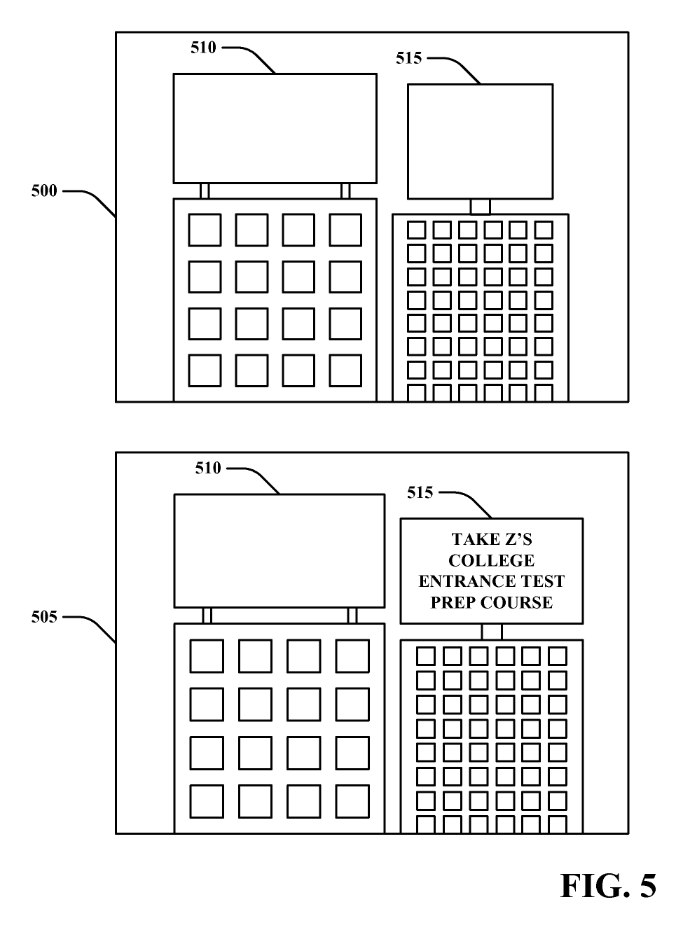

FIG. 5 illustrates one embodiment of a pre-integration scene 500 and a post-integration scene 505. The pre-integration scene 500 can include a first sign 510 and a second sign 510. In the pre-integration scene 500, the first sign 515 and second sign 520 can be blank. The first sign 515 and the second sign 520 being blank can be an example of a communication specifically designed to have a replacement. In one example, the first sign 515 and the second sign 520 in the pre-integration scene 500 can be blue screens.

In the post-integration scene 505, content can be integrated upon the second sign 520. This integration can be performed by the integration component 110 of FIG. 1. In one example with the post-integration scene 505, if no content is selected then the blue screen can remain or blank content can be integrated. In one example, content is selected based on a purchaser selecting for specific content to be integrated on a dynamic portion. If a purchaser does not come forward or make a selection, then a default content can be selected and integrated on the first sign 510 in the post-integration scene 505.

In one embodiment, FIGS. 3, 4, and 5 are an example of where the dynamic portion is an element of the communication and where the content is a replacement element.

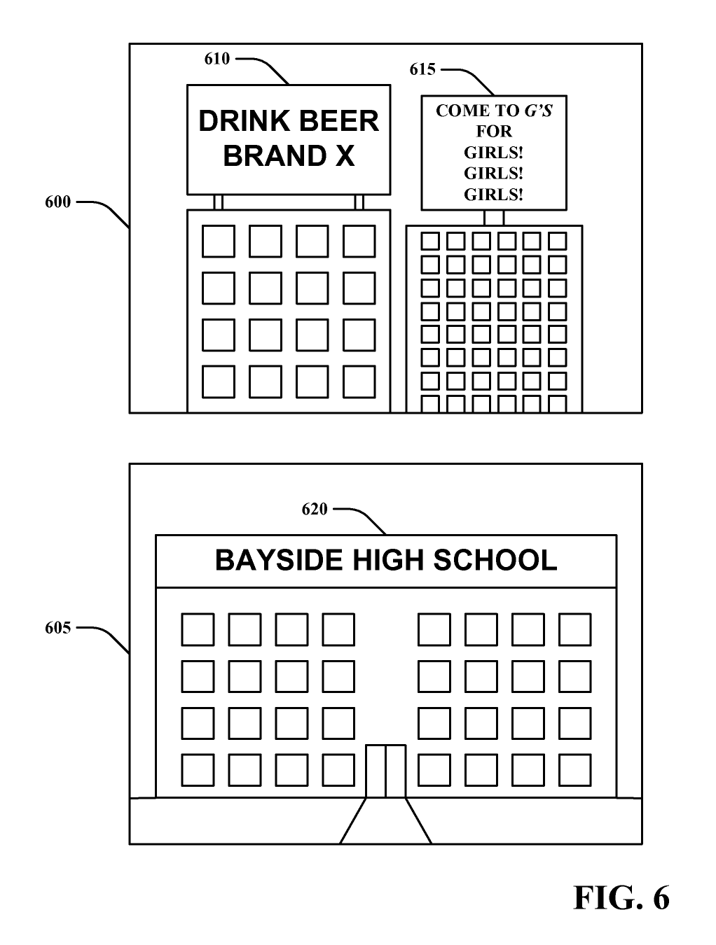

FIG. 6 illustrates one embodiment of a pre-integration scene 600 and a post-integration scene 605. The pre-integration scene 600 can include a first sign 610 and a second sign 615. In the pre-integration scene 600, the first sign 610 and second sign 615 can be blank. The integration component 110 of FIG. 1 can treat the entire pre-integration scene as a dynamic portion. Thus the entire pre-integration scene 600 can be replaced by integrating content. For example, two buildings and signs in pre-integration scene 600 can be replaced with a high school 620 in the post-integration scene 605.

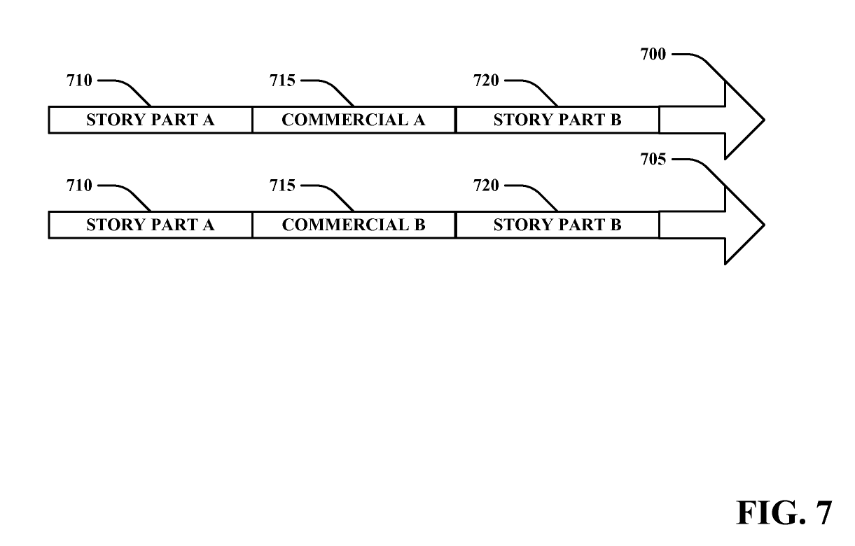

FIG. 7 illustrates one embodiment of a pre-integration communication 700 and a post-integration communication 705. In one embodiment, the pre-integration communication 700 and the post-integration communication 705 are streaming video. The pre-integration communication 700 can include story part A 710, a dynamic portion 715, and story part B 720. The dynamic portion 715 in the pre-integration communication can be a commercial advertisement named ‘commercial A’. In one embodiment, the commercial advertisement is a 30-second video advertisement.

The integration component 110 of FIG. 1 can integrate a content on the dynamic portion 715. In one embodiment, the content is a 30-second video advertisement named ‘commercial B’. The post-integration communication can include story part A 710, the dynamic portion 715 with ‘commercial B’, and story part B 720. In one embodiment, ‘commercial A’ and ‘commercial B’ advertise one product, however ‘commercial B’ can be selected for integration because it is predicted to have a better influence on a recipient set or the recipient set is overexposed to ‘commercial A’ (e.g., a threshold of views for ‘commercial A’ is reached).

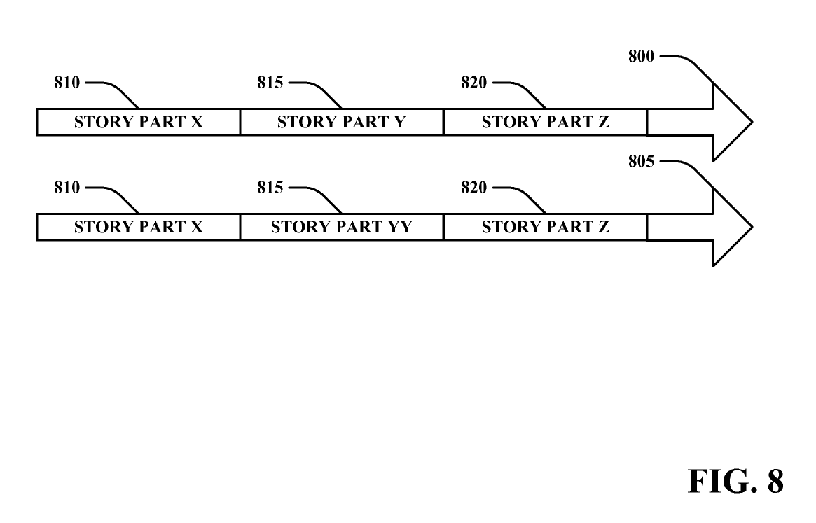

FIG. 8 illustrates one embodiment of a pre-integration communication 800 and a post-integration communication 805. In one embodiment, the pre-integration communication 800 and the post-integration communication 805 are streaming video. The pre-integration communication 800 can include story part X 810, a dynamic portion 815, and story part Z 820. In one embodiment, the dynamic portion 815 is story part Y. In one embodiment, story part X 810 and story part Z 820 are dynamic portions.

The integration component 110 of FIG. 1 can integrate a content on the dynamic portion 815. The content can be a video portion of the post-integration communication 805. The content can be story part YY. Story part YY can replace story part Y seamlessly such that a user does not realize story part YY is content integrated upon a dynamic portion. In one embodiment, story part YY is an alternative ending or story part to story part Y.

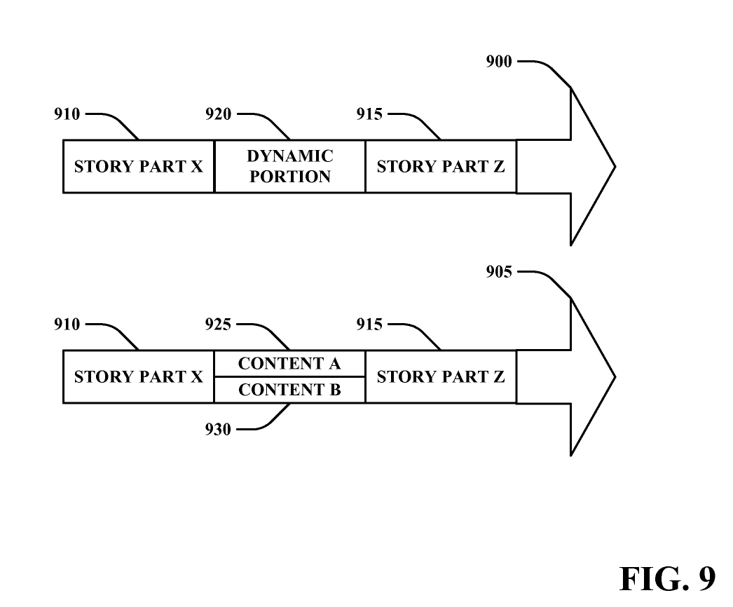

FIG. 9 illustrates one embodiment of a communication with a first view type 900 and a second view type 905. The first view type 900 and the second view type 905 can be different views of the same communication. The communication can include story part X 910 and story part Z 915. In the first view type 900, a dynamic portion 920 is shown. The dynamic portion 920 can be where a ‘story part Y’ may be inputted. When the communication is sent, two scenes can be supplied. A choice can be made on which scene to integrate and the integration component 110 of FIG. 1 can integrate the scene. The second view type 905 shows two possible scenes as content A 925 and content B 930. In one embodiment, content A 925 can be a sexual scene for a movie that has nudity while content B 930 can be a sexual scene for the movie without nudity. Selection on if content A 925 or content B 930 should be integrated can be based, at least in part, on a religious belief of the viewer set, a response to a question (e.g., a question asking the viewer set a content to display), and others.

In one embodiment, FIGS. 6, 7, 8, and 9 are examples of where the dynamic portion is a scene of the communication and where the content is a replacement scene. In one embodiment, FIGS. 7, 8 and 9 are examples of where the communication is a video and where the dynamic portion is a visual aspect of the video.

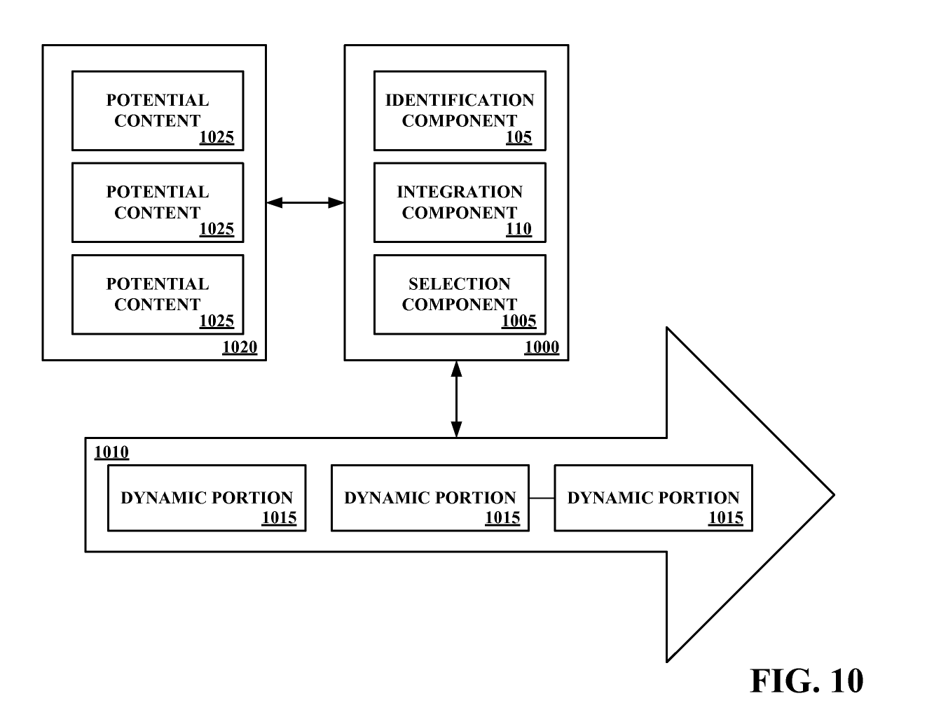

FIG. 10 illustrates one embodiment of a system 1000 with a selection component 1005. The system 1000 includes an identification component 105 and an integration component 110. A communication 1010 identified by the identification component 105 can include dynamic portions 1015. The dynamic portions 1015 can be different elements of a scene, different scenes, and others. The selection component 1005 can evaluate the communication 1010 and identify the dynamic portions 1015. The selection component 1005 can analyze the communication 1010 to determine a preexisting characteristic. The selection component 1005 can select a dynamic portion for the integration component 110 to integrate content upon. Dynamic portion selection can be based, at least in part, on a preexisting characteristic within the communication 1010. Examples of preexisting characteristics in the communication 1010 include pointers, chroma-keyed (e.g. blue screen, green screen) portions, overlaid portions, image-mapped sections, sections identified using visual recognition or other computerized processes, and so forth. This list of examples is considered non-exhaustive, but merely seeks to suggest some possibilities for identifying portions of the communication that are intended to be dynamic, or can be made dynamic, through a number of relative (e.g. appropriate shape recognized within the communication) or absolute (e.g. geometry of portion of scene designated) algorithms.

The selection component 1005 can select content for integration on a selected dynamic portion. In one embodiment, selection can be based, at least in part, on a set of recipients (e.g., one or more recipients). For example, selection can be based on recipient age, race, sexual orientation, political leaning, mood, height, weight, gender, attention level to the communication 1000, other demographic or personal characteristics, or a combination thereof. It is to be appreciated that example characteristics are in no way an exhaustive list, and many other possible factors for inferring preferences can be utilized without deviating from one or more embodiments. The selection component 1005 can have access to a content library 1020 that includes potential content 1025. The selection component 1005 can select the content for integration from the content library 1020.

In one embodiment, content and/or dynamic portion selection is based on meeting a contract obligation. For example, a contract can exist where ‘company X’ pays $Y to have Z number of commercials played in the communication to a certain type of recipient. The selection component 1005 identifies recipients of the certain type and based on that identification selects the dynamic portion and content so that the contract is met.

In one embodiment, the selection component 1005 is presented a communication with two competing scenes. In one example, a first story part is violent and a second story part is not violent. The selection component 1005 selects a story part based, at least in part, on a recipient set. In one example, the selection component 1005 selects the first story part because the recipient set votes to see more violent content. The integration component 110 integrates the first story part on an appropriate dynamic portion.

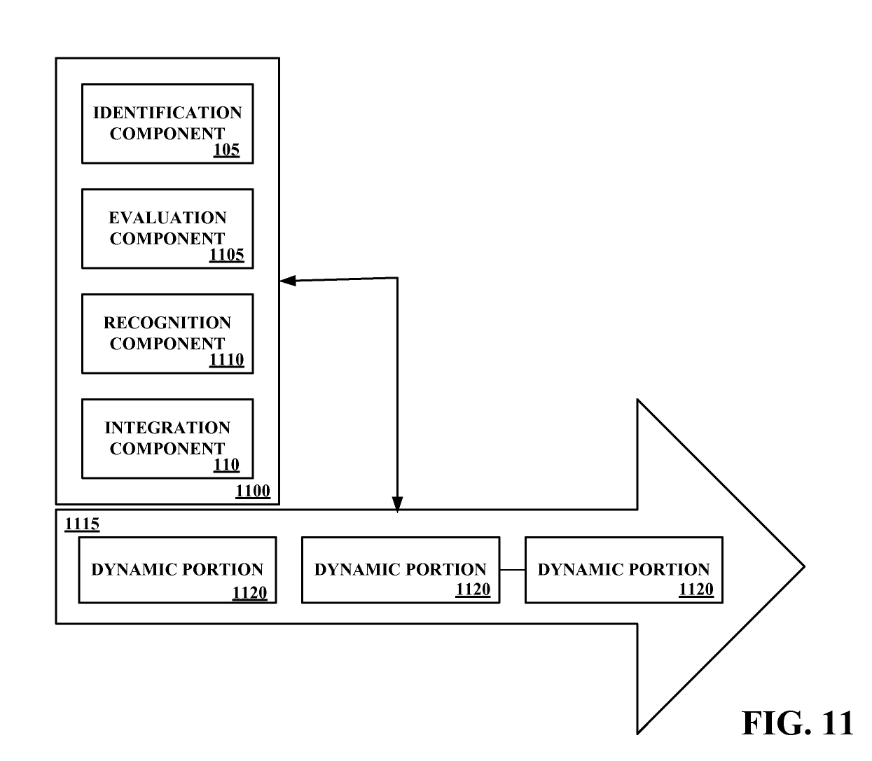

FIG. 11 illustrates one embodiment of a system 1100 with an evaluation component 1105 and a recognition component 1110. An identification component 115 can identify a communication 1115. The evaluation component 1105 analyzes the communication 1115 to produce a communication analysis result. In one example, the evaluation component evaluates a communication type, a communication length, communication subject matter, and others. In one example, the evaluation component 1105 can determine through analysis that the communication 1115 is a half-hour long television comedy show that takes place in Cleveland, Ohio in the 1950s with a family of four and the episode plot is a Christmas mystery on who gave a gift labeled from Santa. The evaluation component 1105 can operate continuously even after a determination is made. In one example, if the Christmas mystery is interrupted by a news story about a tragic event, the evaluation component 1105 can update accordingly (e.g., a tragedy portion of the Christmas mystery can be altered to be less tied to the tragic event). This will in turn influence other components and prevent the inappropriate integration of content that is improper in view of the tragic event. In one example, if the tragic event is an chemical spill at company X, then integration of content for company X can be avoided and/or an element with company X in a scene can experience content integration.

The recognition component 1110 can identify the dynamic portion 1120 based, at least in part, on the communication analysis result. Returning to the above Christmas mystery example, on Christmas morning a child can open a present in one scene. What the present is can be a dynamic portion. The recognition component 1110 can identify the present as the dynamic portion. A determination can be made on if a content should be integrated on the dynamic portion. If the determination is positive, then content can be selected and the integration component 110 can integrate the content on the dynamic portion. In one embodiment, the content is harmonious with the scene. An example of harmonious content is the child opening a fire truck as the present while an example of non-harmonious content is the child opening a carton of cigarettes. In addition to visual aspects of the scene, the dynamic portion can be non-visual. In one example, dialogue of the scene has the child saying ‘thanks for the present.’ The term ‘the present’ can be the dynamic portion and the content can be ‘the fire truck.’

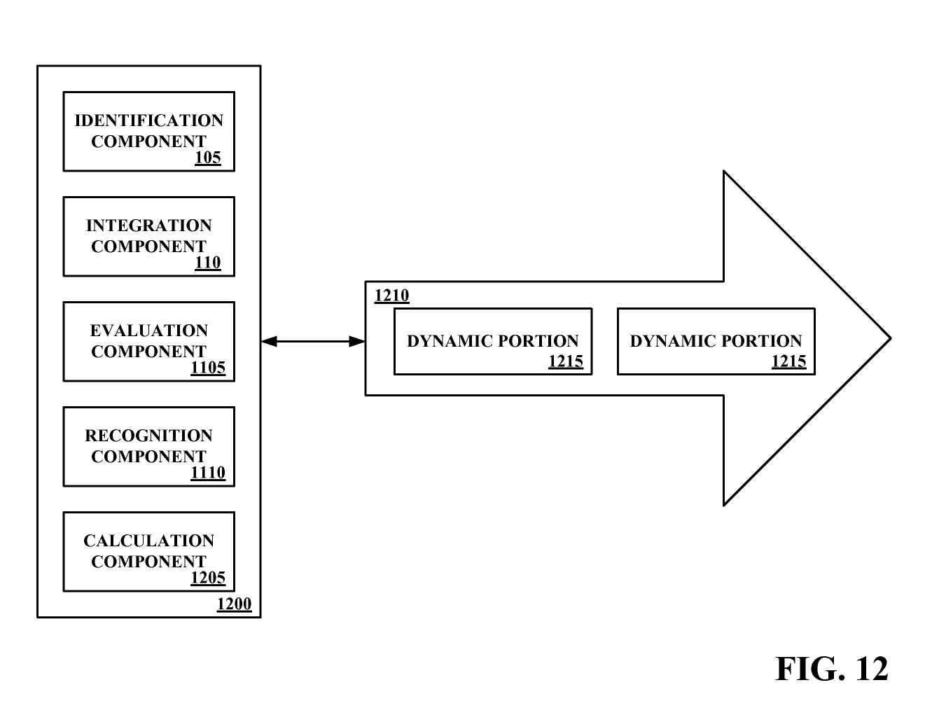

FIG. 12 illustrates one embodiment of a system 1200 with a calculation component 1205. The system 1200 can include an identification component 105, integration component 110, evaluation component 1105, and recognition component 1110. The system also includes a calculation component 1205 that makes a determination on if a potential dynamic portion should be the dynamic portion. The determination is based, at least in part, on a communication analysis result produced by the evaluation component 1105. The integration component 110 integrates the content on the dynamic portion in response to the determination being positive.

In one embodiment, a dynamic portion can be identified as available for content integration. While the dynamic portion can be available, it may not be an appropriate time to integrate content. In one example, a communication can be a live news report on a news channel. Breaking news can occur and a scene is presented discussing a horrible crime. While dynamic portions may be available, integration of content may be inappropriate due to the nature of the horrible crime. Therefore, the calculation component 1205 can determine that one or more of the available dynamic portions should not be integrated with content.

In one embodiment, a communication includes a scene with many elements. While these elements can experience content integration, it may be appropriate to limit how much exposure a recipient set experiences. Therefore, the calculation component 1205 can determine what dynamic portions have content integrated upon them and can determine what dynamic portions do not have content integrated upon them. Depending on the number of integrated content elements, the history of integrated content elements employed, and other factors, the calculation component 1205 can discern how many possible dynamic portions should have content integrated and with what content.

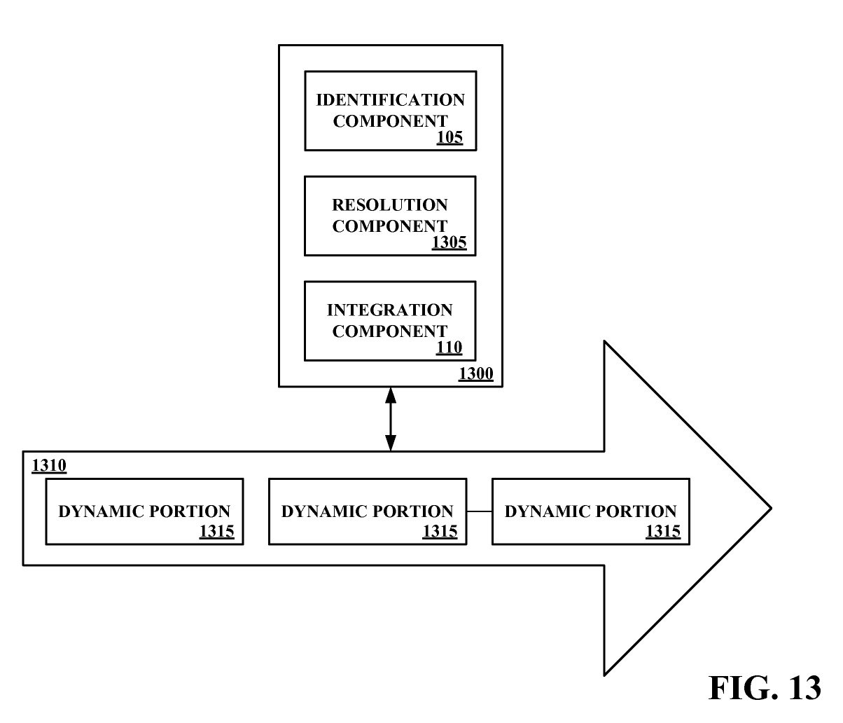

FIG. 13 illustrates one embodiment of a system 1300 with a resolution component 1305. The system 1300 can include an identification component 105 that identifies a communication 1310 with dynamic portions 1315. In one embodiment, content can be integration on the dynamic portions 1315 of the communication 1310 by an integration component 110.

However, there may be times when partial integration (e.g., integration on some dynamic portions) is appropriate. In one example, artificial intelligence can be used to determine if a user is being overexposed to advertisements or other content. This determination can span a number of areas observable by the artificial intelligence. Overexposure can be evaluated for a particular user or users over a variety of physical locations, viewer devices, communications, networks, and so forth. If there is overexposure, then advertisement integration can be limited (e.g., when the content is an advertisement). The resolution component 1305 can be employed to make a determination if the content should be integrated upon the dynamic portion. In one embodiment, the resolution component collects an evaluation result from an evaluation component (e.g., the evaluation component 1105 of FIG. 11). In one embodiment, the determination is based on the evaluation result. In one embodiment, the evaluation result is produced by evaluating the communication 1310 and at least one dynamic portion 1315. In one embodiment, the integration component 110 functions in response to the determination being positive.

In one example, the identification component 105 identifies the communication 1310 with a dynamic portion 1315. The evaluation component 1005 of FIG. 10 analyzes the communication 1310 and dynamic portion 1315 to produce an evaluation result. Other analysis can be used in producing the evaluation result. In one example, processor capabilities, available memory, content, and others can be analyzed and used to produce the evaluation result. The resolution component 1305 can determine that performing integration of content on the dynamic portion 1315 is a waste of resources. In one example, the amount of power to perform the integration is not worth the impact of the content on a recipient set. In one example, a provider of the content is not paying enough to make integration profitable. Thus, the communication 1310 can be disclosed without integrating content or with integrating different or generic content. In one example, a determination is made that integration is worthwhile and a notice is sent to the integration component 110 that integration should occur, what content should be integrated, and on what dynamic portion.

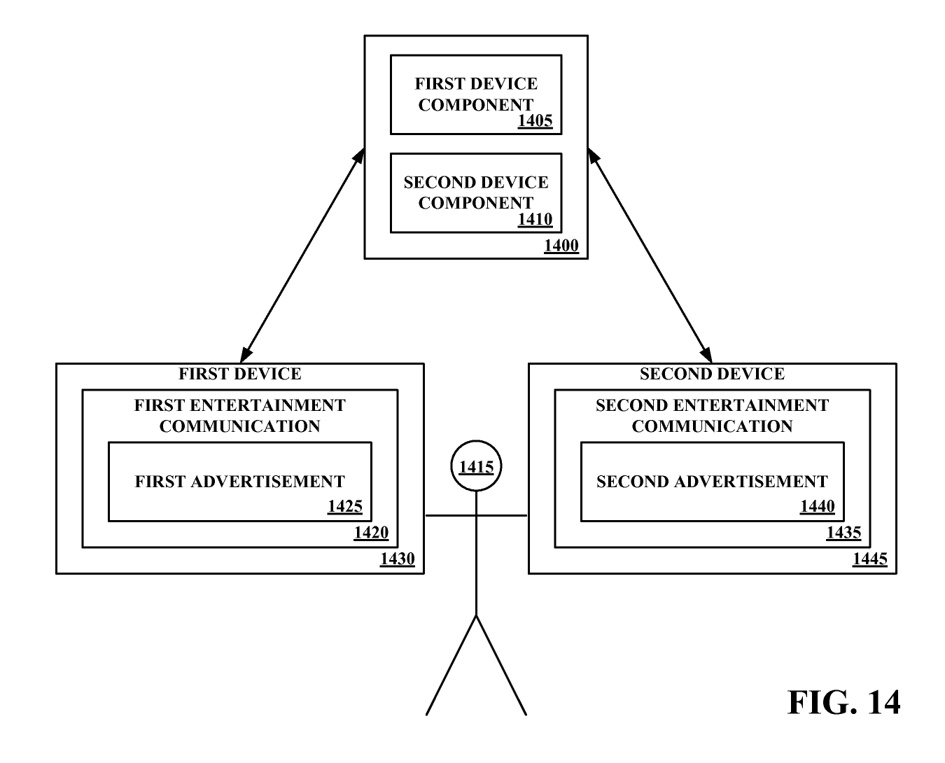

FIG. 14 illustrates one embodiment of a system 1400 with a first device component 1405 and a second device component 1410. A user 1415 can own multiple devices. In one example, the user 1415 owns devices including a personal computer, laptop computer, television with a satellite connection, smart phone, personal digital assistant, and video digital music player. These devices can include advertisement opportunities. Example advertisement opportunities can include playing an audio-visual commercial, playing an audio commercial, integrating advertisement content into an element or scene of a communication, and others. While the devices are discussed as associating with a user, it is to be appreciated that the devices can associate with other entities. Example entities include a family, a sports team, a school student body, and others.

While advertisements may be disclosed in a single form, there may be times when it is appropriate for an advertisement strategy to be employed. The advertisement strategy can be a plan to expose the user 1415 to a commercial set. Advertisements unified in theme can be presented to the user 1415 as part of the advertisement strategy.

The first device component 1405 can cause a first entertainment communication 1420 with a first advertisement 1425 to display on a first device 1430. To display can include visual display, audio display, and others. The second device component 1410 can cause a second entertainment communication 1435 with a second advertisement 1440 to display on a second device 1445. In one embodiment the first device 1430 is associated with a user 1415 and the second device 1445 is associated with the user 1415. Being associated with the user 1415 can include that the user 1415 owns the devices, that the user 1415 is in possession of the devices, that the user 1415 owns the first device 1430 and possesses the second device 1445, that the user 1415 is in a vicinity of the first device 1430 and second device 1445, that the user 1415 can visually see the first device 1430 and second device 1445 simultaneously, and others. The first advertisement 1425 and the second advertisement 1440 can be match or not match. The first device 1430 and the second device 1445 can be the same device or different devices. In one embodiment, the first advertisement 1425 and/or the second advertisement 1440 are displayed as being content integrated on a dynamic portion of a communication. In one embodiment, displaying occurs on the disclosure unit 225 of FIG. 2.

In one embodiment, the first advertisement 1425 and the second advertisement 1440 can be unified in theme. In one example, the first advertisement 1425 can be a radio advertisement for ‘soda X’ while the second advertisement 1440 can be a television commercial for ‘soda X’. Since the first advertisement 1425 and the second advertisement 1440 attempt to convince a user to buy ‘soda X’, the advertisements are unified in theme.

In one example, the first advertisement 1425 can be an Internet streaming video advertisement for ‘soda X’ while the second advertisement 1440 can be a webpage banner advertisement for ‘soda Y’. Soda X and Soda Y can be owned by one company. Since the first advertisement 1425 and the second advertisement 1440 attempt to convince a user to buy products from one company, the advertisements are unified in theme.

In one example, the first advertisement 1425 can be a television advertisement for a football game while the second advertisement 1440 can be a television advertisement for a basketball game. Since the first advertisement 1425 and the second advertisement 1440 attempt to convince a user watch similar events, the advertisements are unified in theme. Alternatively, the advertisements could be directed to disclose specific aspects relating to one sport's games, or equipment and memorabilia related to the currently playing game.

The system 1400 can include a component (e.g., a component that is part of the first device component 1405 and/or the second device component 1410) to evaluate the user 1415. Based on a result of this evaluation, an advertisement strategy for the user can be developed by the component. The advertisement strategy can be used in selecting advertisements unified in theme to present to the user 1415. The system 1400 can cause at least some selected advertisements to display on devices associated with the user 1415.

In one embodiment, the advertisement strategy is personalized to the user. In one embodiment, the advertisement strategy is designed for a personal classification, where the user is part of the classification. In one example, the personal classification is age, gender, personal interests, and other demographic and personal factors.

In one embodiment, the first device component 1405 and/or the second device component 1410 can be part of the communication provider 205 of FIG. 2, the distributor 210 of FIG. 2, the satellite 215 of FIG. 2, the relay 220 of FIG. 2, the disclosure unit 225 of FIG. 2, or a combination thereof

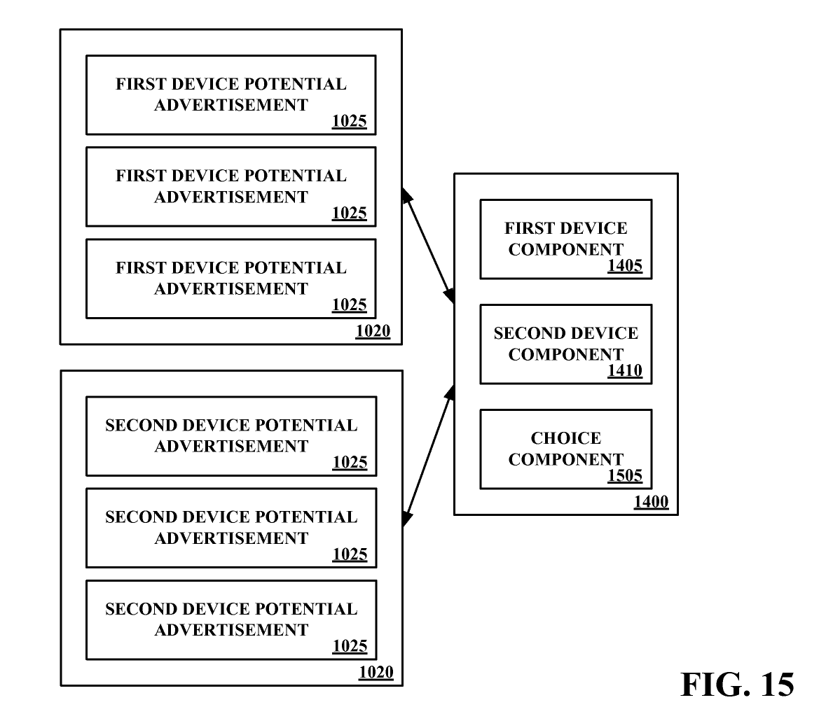

FIG. 15 illustrates one embodiment of a system 1500 with a choice component 1505. The system includes a first device component 1405 and a second device component 1410 that cause a first advertisement and a second advertisement to display on a first device and a second device respectively.

A choice component 1505 makes a selection for the first advertisement and the second advertisement. In one embodiment, the selection is based, at least in part, on an advertisement strategy for the user.

In one embodiment, the advertisement strategy is a strategy to convince a user to purchase a particular product. An advertiser can produce the advertisement strategy to the system 1500. The choice component 1505 can evaluate the advertisement strategy and select advertisements for display to a user.

In one embodiment, the choice component 1505 can have access to an advertisement library 1510 that includes first device potential advertisements 1515. The choice component 1505 can have access to an advertisement library 1520 that includes second device potential advertisements 1525. The choice component 1505 can evaluate the advertisement strategy to produce an advertisement strategy evaluation result. Based, at least in part, on the advertisement strategy evaluation result, the choice component 1515 selects a first advertisement and a second advertisement.

In one embodiment, the choice component evaluates 1505 the user to produce a user evaluation result. Based on this result, the choice component 1505 can create the advertisement strategy.

In one example, a user can regularly drink ‘soda A.’ A company that makes ‘soda B’ can evaluate the user and create an advertisement strategy for the user to convince the user to buy ‘soda A.’ In one example, the user has purchased products more frequently when 30-second commercials are played on visual devices. The choice component 1505 can select a first visual device and a second visual device for advertisement display based on a user evaluation (e.g., evaluating a user's product purchasing history in relation to user advertisement exposure). The choice component 1505 can select a 30-second advertisement category in an appropriate library and choose 30-second advertisements that may be effective in convincing the user to buy ‘soda A.’ The selection can be based on user history, the advertisement strategy, and others.

In one embodiment, as part of the advertisement strategy a first advertisement and a second advertisement can interrelate. In one example, the first advertisement is a first story part while the second advertisement is a second story part. In one embodiment, the second advertisement refers back to the first advertisement. In one example, the first advertisement is displayed on a television while the user is watching a cop drama. The second advertisement can state ‘as we told you previously when you were watching the cop drama, you should buy soda A.’

In one embodiment, the system 1500 can create an advertisement strategy, receive an advertisement strategy from another source, or modify an existing advertisement strategy. In one example, the advertisement strategy is explicit instructions on advertisements to show, when to show the advertisements, what devices to show the advertisements on, and others. The choice component 1505 can select the first advertisement and the second advertisement based, at least in part, on the explicit instruction. In one example, the advertisement strategy includes a data set. The choice component 1505 evaluates the data set to produce a data set evaluation result. Based, at least in part, on the data set evaluation result, the choice component 1505 can select the first advertisements, select the second advertisement, select when to show the first advertisement, select when to show the second advertisement, select the first device, select the second device, and others.

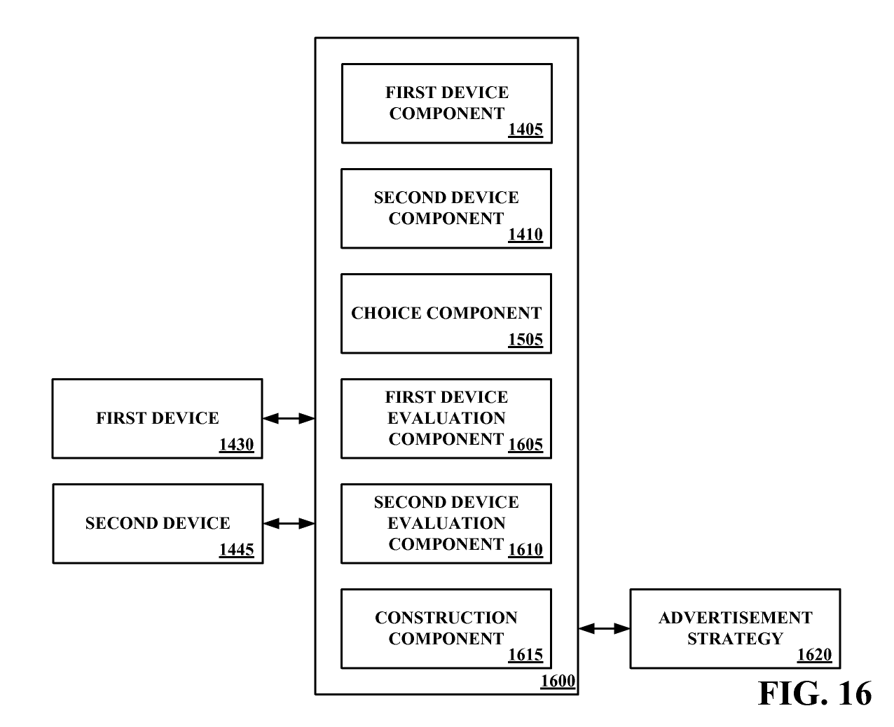

FIG. 16 illustrates a system 1600 with a first device evaluation component 1605, a second device evaluation component 1610, and a construction component 1615. Devices associated with a user can be evaluated. A first device evaluation component 1605 can evaluate a first device 1430 to produce a first device evaluation result. A second device evaluation component 1610 can evaluate the second device 1445 to produce a second device evaluation result. The construction component 1615 can create an advertisement strategy 1620 based, at least in part, on the first device evaluation result and the second device evaluation result.

While the system 1600 shows a first device evaluation component 1605 and a second device evaluation component 1610, it is to be appreciated that other device evaluation components can be used in creating the advertisement strategy 1620 (e.g., third device evaluation component, fourth device evaluation component, and others).

In one embodiment, the system 1600 can determine devices capable of disclosing and advertisement associated with the user. These devices can be evaluated by the system 1600 to produce an evaluation result. The advertisement strategy can be created based, at least in part, on the evaluation result. In one example, the advertisement strategy indicates devices to use, what advertisements to display on what devices, when advertisement are to be displayed, and others.

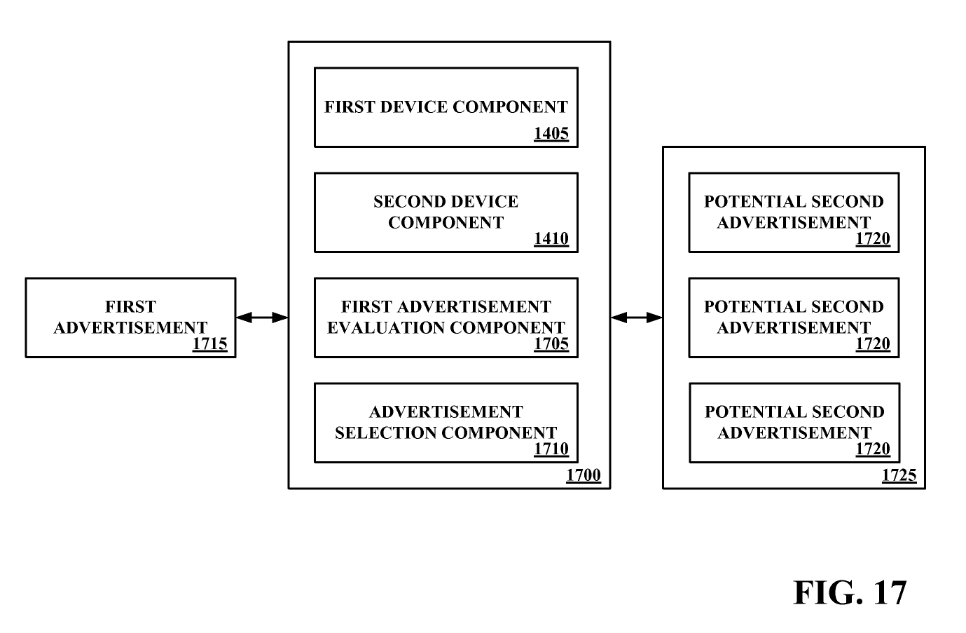

FIG. 17 illustrates one embodiment of a system 1700 with a first advertisement evaluation component 1705 and an advertisement selection component 1710. The system 1700 can also include a first device component 1405 and a second device component 1410. The system 1700 can cause advertisements to be displayed according to an advertisement strategy.

In one embodiment, the advertisement strategy can be a dynamic strategy that can be modifiable as the strategy is implemented. Based on how a first advertisement is received, based on a device used as the first device, based on available devices at a particular time, then the advertisement strategy can be modified.

The first advertisement evaluation component 1705 can evaluate a first advertisement 1715 to produce a first advertisement evaluation result. The advertisement selection component 1710 can make a selection for the second advertisement. The selection can be based, at least in part, on the first advertisement evaluation result. In one embodiment, the selection is made from potential second advertisements 1720 in a second advertisement library 1725.

In one embodiment, the first advertisement 1715 is displayed on the first device. However, the user does not pay much attention to the first advertisement 1715. In one example, user attention level is determined by an eye-contact sensor associated with the first device. Based on a user attention level to the first advertisement 1715, the second advertisement can be selected. In one example, the second advertisement is the first advertisement 1715 (e.g., the first advertisement 1715 is replayed). In one example, the second advertisement is more attention grabbing then the first advertisement 1715.

In one embodiment, the first advertisement 1715 is displayed on the first device. After the first advertisement 1715 is displayed the user can purchase the product. In one example, the first advertisement 1715 can be classified as effective and a similar advertisement can be displayed as the second advertisement. In one example, since a purchase of the product is made, then an inference can be drawn that the user may be less likely to make another purchase of the product. Therefore, an advertisement selling a brand different from that of the product, but owned by the company that sells the product can be selected as the second advertisement.

In one embodiment, the first advertisement 1715 is presented on the first device. The first advertisement 1715 can include a user interaction portion where a user responds to the first advertisement 1715 to produce a user response. Selection for the second advertisement can be based, at least in part, on a user response. In one example, the user chooses a second advertisement. In one example, the user produces a rating for the first advertisement 1715 and the rating is used to select the second advertisement.

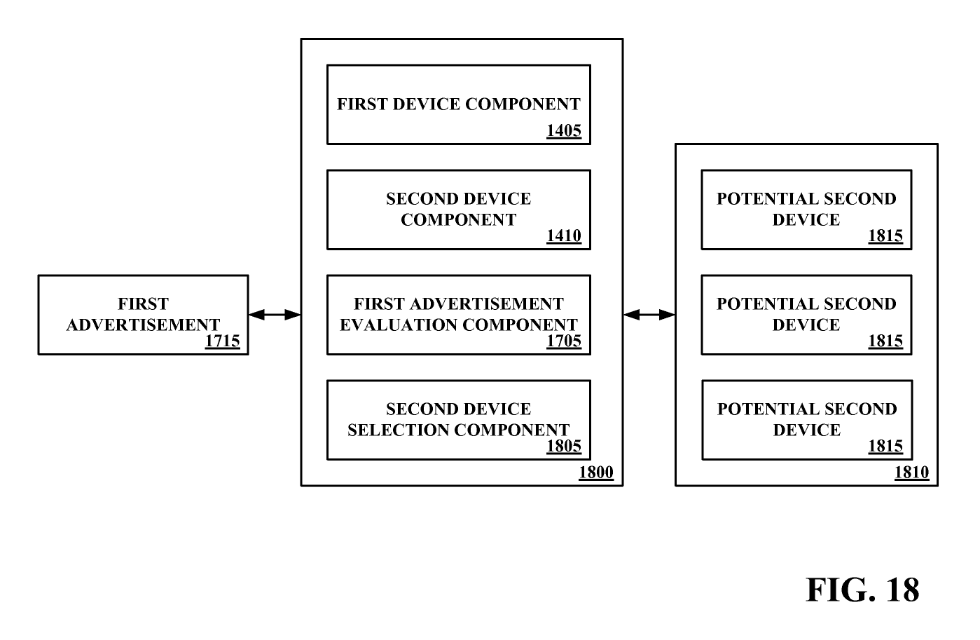

FIG. 18 illustrates one embodiment of a system 1800 with first advertisement evaluation component 1705 and a second device selection component 1805. The system 1800 can include a first device component 1805 and a second device component 1810. The system 1800 can be used to select a second device based on a result of a first advertisement 1715 being displayed on a first device.

The first advertisement evaluation component 1705 can evaluate the first advertisement 1715 to produce a first advertisement analysis result. The second device selection component 1805 can select a second device based, at least in part, on the first advertisement analysis result. In one embodiment, a device set 1810 is available to the second device selection component 1805. The device set 1810 can be a group of potential second devices 1815 associated with a user capable of displaying a second advertisement.

In one embodiment, the first advertisement 1715 can be an advertisement displayed in an audio manner on a radio without a visual aspect. An advertisement strategy may consider an advertisement with a visual aspect more effective than an advertisement without a visual aspect. Since the first device was a radio, the advertisement strategy may suggest that the second device not be another radio without a visual aspect. Thus, the second device selection component 1805 can select a second device that includes a visual aspect. In one embodiment, the system 1800 includes the advertisement selection component 1710 of FIG. 17. In one embodiment, the advertisement selection component 1710 of FIG. 17 and the second device selection component 1805 work together in making selections. In one example, selection of a second device and a second advertisement is coordinated together to improve effectiveness (e.g., how effective an advertisement is on a user).

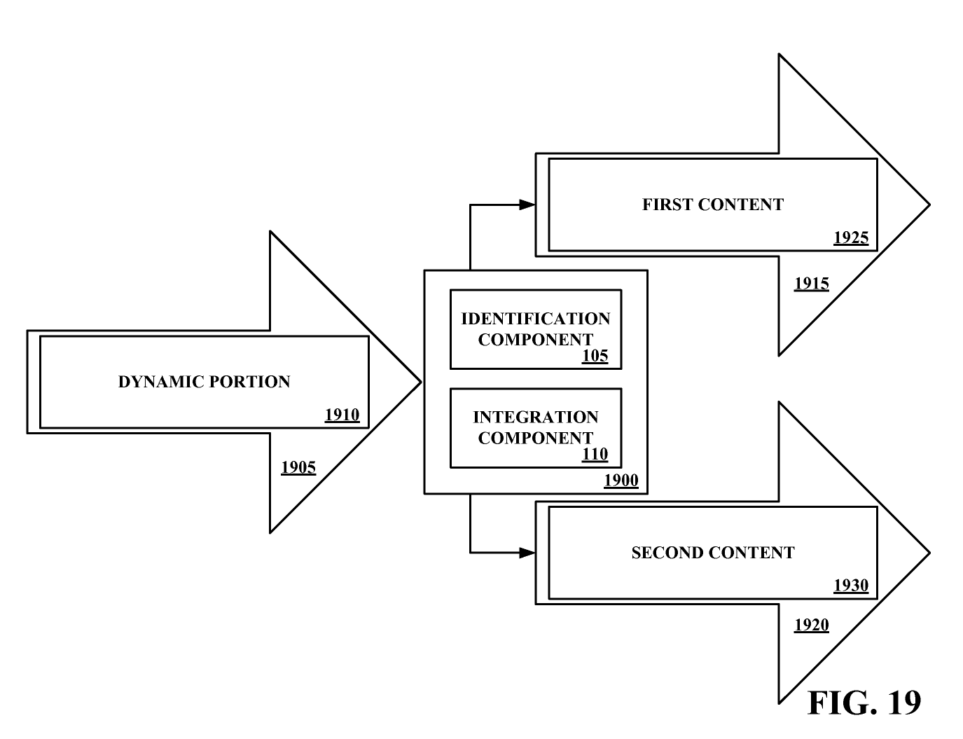

FIG. 19 illustrates one embodiment of a system 1900 that includes an identification component 105 and an integration component 110. The identification component can identify a communication 1905. The communication 1905 can include a dynamic portion 1910. An integration component 110 can integrate a content on the dynamic portion 1910 of the communication 1905. In one embodiment, selection of the content is based, at least in part, on a set of recipients (e.g., set of recipients of the communication 1905) and the content is harmonious with the communication 1905.

In one embodiment, the system 1900 produces two communication versions: a first communication version 1915 and a second communication version 1920. The first communication version 1915 can be integrated with a first content 1925 while the second communication version 1920 can be integrated with a second content 1930.

In one embodiment, the first content 1925 advertises a first product and the second content 1930 advertises a second product. In one example, the first product and the second product are produced by one company. In one example, the first product and the second product are produced by different companies. In one embodiment, the first content 1925 and the second content 1930 advertise one product, but are different advertisements.

The following methodologies are described with reference to figures depicting the methodologies as a series of blocks. These methodologies may be referred to as methods, processes, and others. While shown as a series of blocks, it is to be appreciated that the blocks can occur in different orders and/or concurrently with other blocks. Additionally, blocks may not be required to perform a methodology. For example, if an example methodology shows blocks 1, 2, 3, and 4, it may be possible for the methodology to function with blocks 1-2-4, 1-2, 3-1-4, 2, 1-2-3-4, and others. Blocks may be wholly omitted, re-ordered, repeated or appear in combinations not depicted. Individual blocks or groups of blocks may additionally be combined or separated into multiple components. Furthermore, additional and/or alternative methodologies can employ additional, not illustrated blocks, or supplemental blocks not pictured can be employed in some models or diagrams without deviating from the spirit of the features. In addition, at least a portion of the methodologies described herein may be practiced on a computer-readable medium storing computer-executable instructions that when executed by a computer cause the computer to perform a methodology.

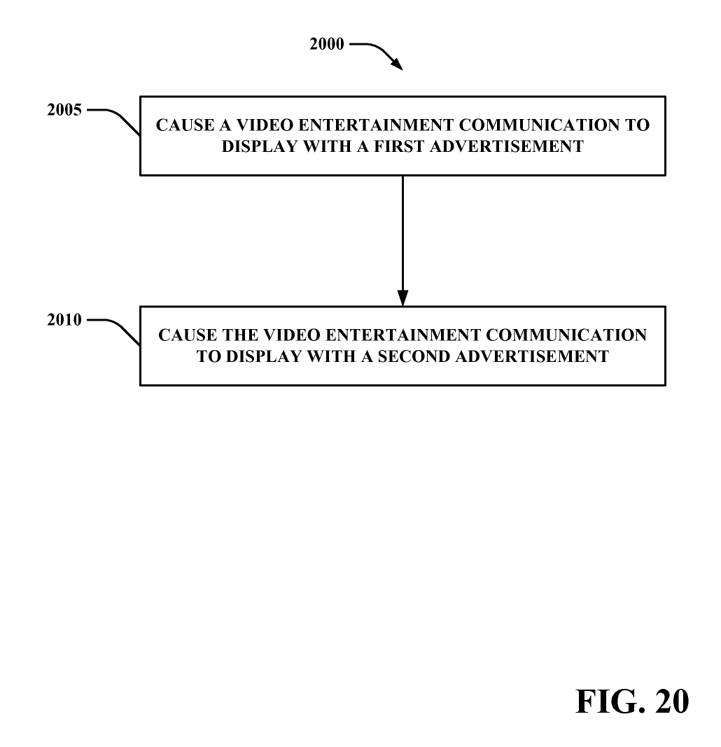

FIG. 20 illustrates one embodiment of a method 2000 for causing communication display. A content provider can supply a communication that includes a dynamic portion. An advertisement can integrate on the dynamic portion. The advertisement can be tailored to different recipient sets. The communication can be displayed to the different recipient sets. A first recipient set can be presented the communication with a first advertisement while simultaneously a second recipient set can be presented the communication with a second advertisement.

The method 2000 includes, at 2005, causing a video entertainment communication to display with a first advertisement at a first location. The method 2000 includes, at 2010, causing the video entertainment communication to display with a second advertisement at a second location. The first advertisement can integrated into a dynamic substance portion of the video entertainment communication when displayed. The second advertisement can integrated into the dynamic substance portion of the video entertainment communication.

In one embodiment, the dynamic substance portion is a part of a scene in content of the video entertainment communication. In one example, the video entertainment communication is made up of story segments and commercial segments. The dynamic substance portion can be part of the story segment. The dynamic substance portion can be a scene of a story segment or an element of a scene. In one example, a scene is a series of screenshots. In one embodiment, a scene is a series of screenshots linked with a common background, storyline, camera view, and others.

In one embodiment, the first advertisement can be caused to display at the first location concurrently with the second advertisement being caused to display at the second location. In one example, the first advertisement is caused to display simultaneously with the second advertisement (e.g., the first advertisement and second advertisement are displayed on a screen at one time). In one example, the first advertisement is displayed while the second advertisement is caused to display by being stored in a computer-readable medium (e.g., as part of a digital video recorder). At a time after the first advertisement is displayed, the second advertisement can be displayed.

In one example, a company can desire to disclose targets advertisement to a first viewer set and as second viewer set. The first view set can be groups where a teenager resides in a household while the second set can be groups where a teenager does not reside in a household. The company can use a computer-readable medium to cause the first view set to be presented a television show with a commercial for ‘soda X’ that is geared towards teenagers. The company can use the computer-readable medium to cause the second viewer set to be presented the television show with a commercial for ‘soda X’ that is not targeted to an age classification. In one embodiment, the commercials are for different products.

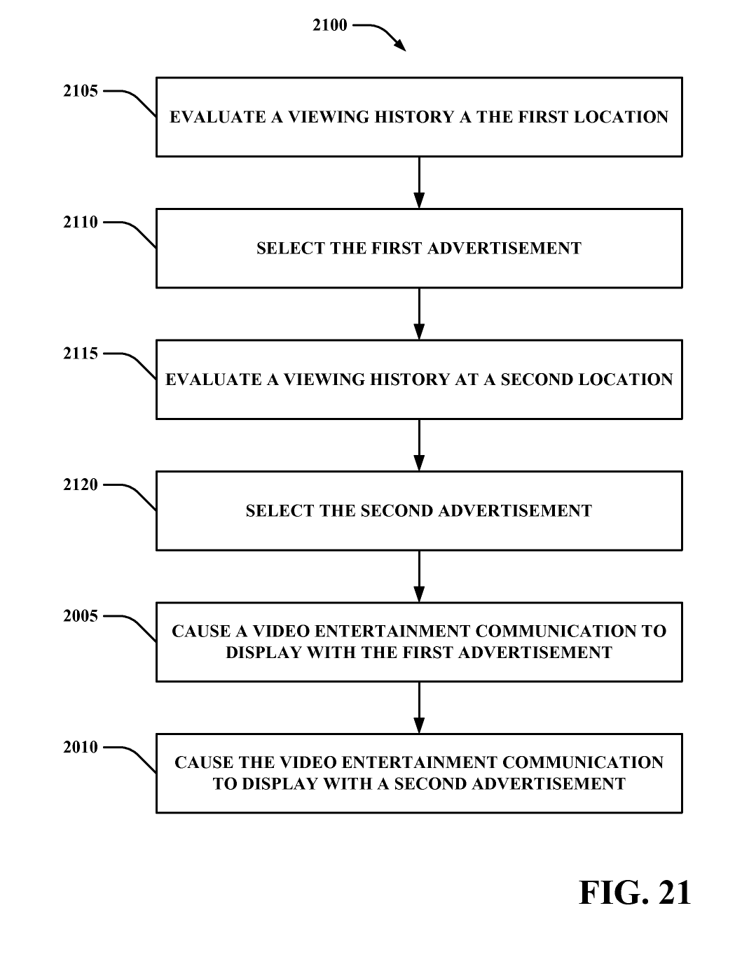

FIG. 21 illustrates one embodiment of a method 2100 for causing communication display. In one embodiment, different viewing locations can watch one television program. However, advertisements in the television program can be customized to a group viewing the program or expected to be viewing the program.

In one embodiment, at 2105, a viewing history is evaluated for a first location to produce a first location viewing history result. The viewing history can include programs watched, rating of programs watched, reception to commercials, responses to commercials (e.g., if a user visits a website advertised in a commercial), volume levels during programming, how often channels are changed when a commercial comes on, if a view has other websites open when watching a video entertainment communication through a website, how often individual users watch a program, conversation levels while the video entertainment communication is displayed, and others. At 2110, the first advertisement can be selected. Selection for the first advertisement can be based, at least in part, on the first location viewing history result. At 2115, a viewing history for the second location can be evaluated to produce a second location viewing history result. At 2120, the second advertisement can be selected. Selection for the second advertisement can based, at least in part, on the second location viewing history result.

In one embodiment, selection for the first advertisement and second advertisement is collaborative. In one example, selection for the first advertisement can be based, at least in part, on the first location viewing history result and the second location viewing history result. In one example, selection for the first advertisement weighs the first location viewing history result more than the second location viewing history result.

In one embodiment, the first location is remote from the second location. In one example, the first location is a first home and the second location is a second home. In one example, the first location is a device in a store and the second location is a device in a vehicle (e.g., automobile, motorboat, airplane, and others).

In one embodiment, the first location is local to the second location. In one example, the first location is a device (e.g., television) in a downstairs room (e.g., living room) of a home and the second location is a device (e.g., television) in an upstairs room (e.g., bedroom) of the home.

At 2005, the video entertainment communication can be caused to display with a first advertisement at the first location. At 2010, the video entertainment communication can be caused to display with a second advertisement at the second location. In one embodiment the first advertisement is caused to display at the first location concurrently with the second advertisement being caused to display at the second location. In one embodiment, the first advertisement is integrated into a dynamic substance portion of the video entertainment communication when displayed. In one embodiment, the second advertisement is integrated into the dynamic substance portion of the video entertainment communication.

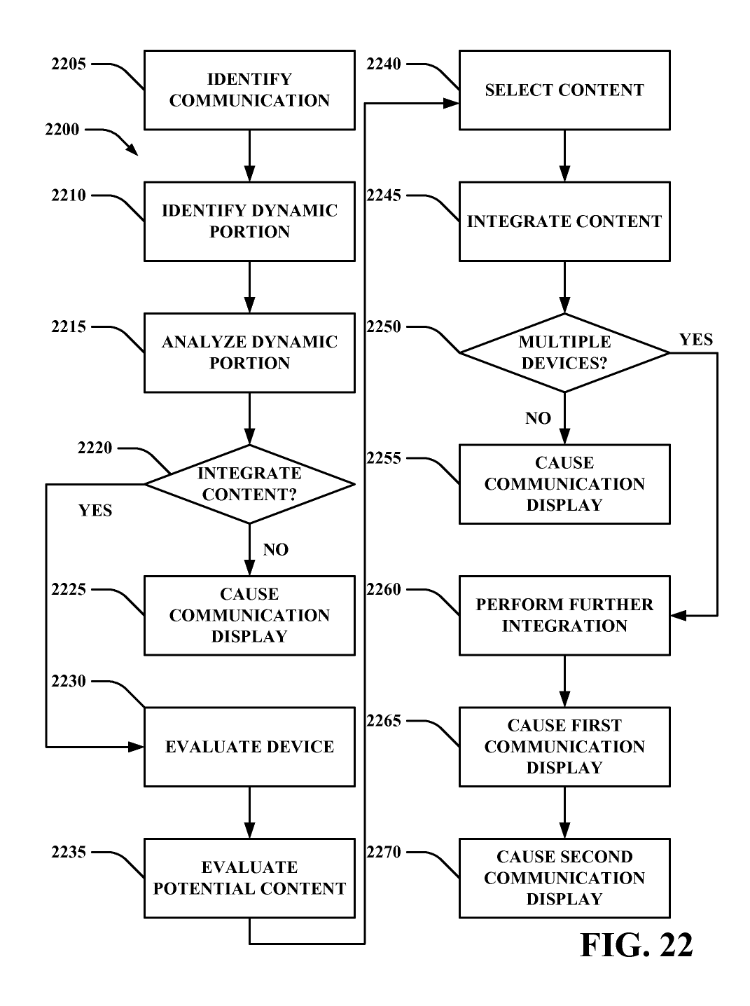

FIG. 22 illustrates one embodiment of a method 2200 for causing communication display. A communication can be received and at 2205 the communication can be identified. Communication identification can include determining that a communication is received, determining communication type, and others. At 2210, a dynamic portion of the communication can be identified. In one embodiment, a component analyzes bits of the communication to determine parts of the communication that can have content integrated upon them. At 2215, an identified dynamic portion can be analyzed.

At 2220, a determination can be made on if content should be integrated upon the dynamic portion. If the determination is no, then at 2225 the communication can be caused to display without content integration. If the determination is yes, then at 2230 a device upon which the communication is displayed can be evaluated. In one embodiment, the device is evaluated to determine device characteristics. Along with device evaluation, at 2235 potential content can be evaluated. In one embodiment, the potential content is evaluated according to device characteristics.

At 2240 content is selected for integration upon the identified dynamic portion. In one example, a device for use in displaying the communication displays in black-and-white. Therefore, content is selected that is more effective in black-and-white then other content. At 2245, a content is integrated on a dynamic portion of the communication.

Communications with integrated content can be displayed on multiple devices. More than one communication can be displayed on one device and more than one device can receive a communication. At 2250 a determination is made if multiple devices are used. If the determination is no, then the communication is displayed at 2255.

If the determination is yes, then other integration can occur at 2260. At 2260, other content selection can occur, other dynamic portion identification can occur, and others. At 2265 there can be causing a video entertainment communication to display with a first advertisement at a first location as well as causing a first entertainment communication with a first advertisement to display on a first device. At 2270 there can be causing the video entertainment communication to display with a second advertisement at a second location as well as a second device component to cause a second entertainment communication with a second advertisement to display on a second device.

In one example, data structures may be constructed that facilitate storing data on a computer-readable medium and/or in a data store. Thus, in one example, a computer-readable medium may store a data structure that includes data associated with methods 2000, 2100, and 2200 in FIGS. 20, 21, and 22 respectively. In one embodiment, the computer-readable medium can be part of the communication provider 205 of FIG. 2, the distributor 210 of FIG. 2, the satellite 215 of FIG. 2, the relay 220 of FIG. 2, the disclosure unit 225 of FIG. 2, or a combination thereof

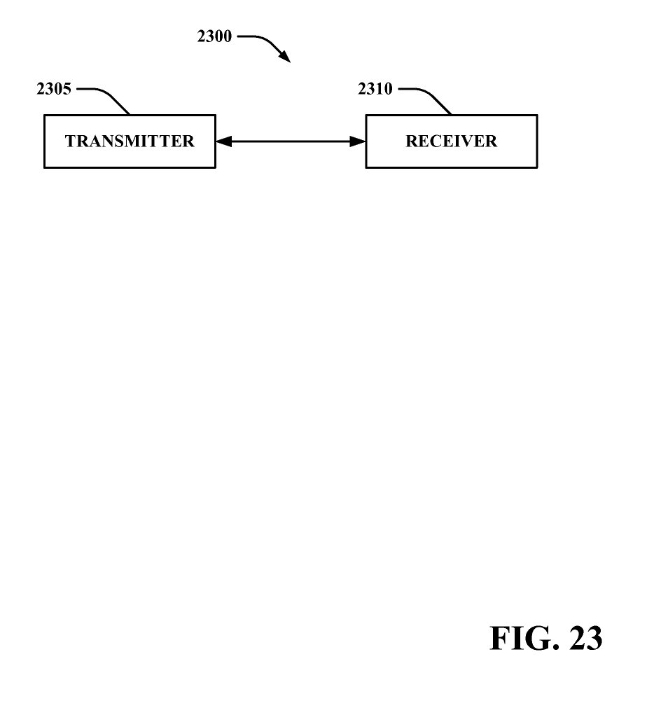

FIG. 23 illustrates one embodiment of a system 2300 that may be used in practicing at least one aspect disclosed herein. The system 2300 includes a transmitter 2305 and a receiver 2310. In one or more embodiments, the transmitter 2305 can include reception capabilities and/or the receiver 2310 can include transmission capabilities. The transmitter 2305 and receiver 2310 can each function as a client, a server, and others. The transmitter 2305 and receiver 2310 can each include a computer-readable medium used in operation. The computer-readable medium may include instructions that are executed by the transmitter 2305 or receiver 2310 to cause the transmitter 2305 or receiver to perform a method. The transmitter 2305 and receiver 2310 can engage in a communication with one another. This communication can over a communication medium. Example communication mediums include an intranet, an extranet, the Internet, a secured communication channel, an unsecure communication channel, radio airwaves, a hardwired channel, a wireless channel, and others. Example transmitters 2305 include a base station, a personal computer, a cellular telephone, a personal digital assistant, and others. Example receivers 2310 include a base station, a cellular telephone, personal computer, personal digital assistant, and others. The example network system 2300 may function along a Local Access Network (LAN), Wide Area Network (WAN), and others. In one embodiment, aspects disclosed herein, including communication across the network system 2300 can include security measures (e.g., encryption, decryption, keys, and others). The aspects described are merely an example of network structures and intended to generally describe, rather than limit, network and/or remote applications of features described herein.

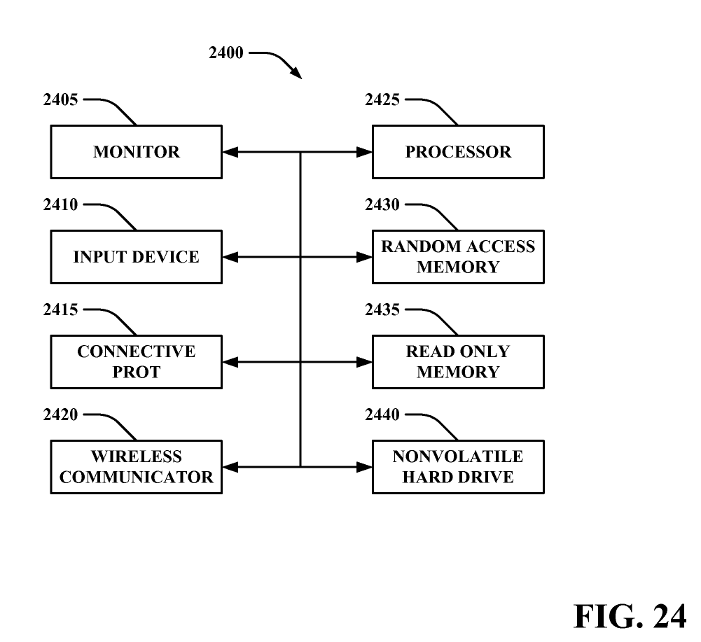

FIG. 24 illustrates one embodiment of a system 2400, upon which at least one aspect disclosed herein can be practiced. In one embodiment, the system 2400 can be considered a computer system that can function in a stand-alone manner as well as communicate with other devices (e.g., a central server, communicate with devices through data network (e.g., Internet) communication, etc). Information can be displayed through use of a monitor 2405 and a user can provide information through an input device 2410 (e.g., keyboard, mouse, touch screen, etc.). In one embodiment, the monitor 2405 is used to display the video entertainment communication. A connective port 2415 can be used to engage the system 2400 with other entities, such as a universal bus port, telephone line, attachment for external hard drive, and the like. Additionally, a wireless communicator 2420 can be employed (e.g., that uses an antenna) to wirelessly engage the system 2400 with another device (e.g., in a secure manner with encryption, over open airwaves, and others). A processor 2425 can be used to execute applications and instructions that relate to the system 2400. Storage can be used by the system 2400. The storage can be a form of a computer-readable medium. Example storage includes random access memory 2430, read only memory 2435, or nonvolatile hard drive 2440.

The system 2400 may run program modules. Program modules can include routines, programs, components, data structures, logic, etc., that perform particular tasks or implement particular abstract data types. The system 2400 can function as a single-processor or multiprocessor computer system, minicomputer, mainframe computer, laptop computer, desktop computer, hand-held computing devices, microprocessor-based or programmable consumer electronics, and the like.

It is to be appreciated that at least on aspect disclosed herein can be practiced through use of artificial intelligence techniques. In one example, a determination or inference described herein can, in one embodiment, be made through use of a Bayesian model, Markov model, statistical projection, neural networks, classifiers (e.g., linear, non-linear, etc.), using provers to analyze logical relationships, rule-based systems, or other technique.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, innovative aspects are not limited to the specific details, the representative apparatus, and illustrative examples shown and described. Thus, this application is intended to embrace alterations, modifications, and variations that fall within the scope of the appended claims.

Functionality described as being performed by one entity (e.g., component, hardware item, and others) may be performed by other entities, and individual aspects can be performed by a plurality of entities simultaneously or otherwise. For example, functionality may be described as being performed by a processor. One skilled in the art will appreciate that this functionality can be performed by different processor types (e.g., a single-core processor, quad-core processor, etc.), different processor quantities (e.g., one processor, two processors, etc.), a processor with other entities (e.g., a processor and storage), a non-processor entity (e.g., mechanical device), and others.

In addition, unless otherwise stated, functionality described as a system may function as part of a method, an apparatus, a method executed by a computer-readable medium, and other embodiments may be implemented in other embodiments. In one example, functionality included in a system may also be part of a method, apparatus, and others.

Where possible, example items may be combined in at least some embodiments. In one example, example items include A, B, C, and others. Thus, possible combinations include A, AB, AC, ABC, AAACCCC, AB. Other combinations and permutations are considered in this way, to include a potentially endless number of items or duplicates thereof.

1. A non-transitory computer-readable medium storing computer-executable instructions to perform a method, the method, comprising:
identifying a communication;
determining that content among prospective content is harmonious with the communication; and
in response to determining that the content is harmonious with the communication, integrating the content on a dynamic portion of the communication,
where different prospective content is rejected as the content because the prospective content is not harmonious with the communication, and
where harmony among the content and the communication is based, at least in part, on a set of recipients of the communication with the content integrated upon the dynamic portion.

2. The non-transitory computer-readable medium of claim 1, wherein selecting the dynamic portion is based, at least in part, on a preexisting characteristic within the communication.

3. The non-transitory computer-readable medium of claim 1, wherein the content is integrated local to the set of recipients.

4. The non-transitory computer-readable medium of claim 1, wherein the content is integrated local to a producer of the communication.

5. The non-transitory computer-readable medium of claim 1, wherein the content is integrated local to a distributor of the communication.

6. The non-transitory computer-readable medium of claim 1, wherein the dynamic portion is a scene of the communication and where the content is a replacement scene.

7. The non-transitory computer-readable medium of claim 1, wherein the dynamic portion is an element of the communication and where the content is a replacement element.

8. The non-transitory computer-readable medium of claim 1, wherein the communication is a video and where the dynamic portion is a visual aspect of the video.

9. The non-transitory computer-readable medium of claim 1, the method comprising:
determining if the content is integrated upon the dynamic portion, where the determination is based on an evaluation result produced by evaluating the communication and the dynamic portion and wherein integrating is performed in response to the determination being positive.

10. The non-transitory computer-readable medium of claim 1, the method comprising:
proactively analyzing the communication to produce a communication analysis result; and
proactively identifying the dynamic portion based, at least in part, on the communication analysis result.

11. The non-transitory computer-readable medium of claim 10, the method comprising:
determining if a potential dynamic portion is the dynamic portion based, at least in part, on the communication analysis result,
where the content is integrated on the dynamic portion in response to the determination being positive.

12. A non-transitory computer-readable medium storing computer-executable instructions to perform a method, the method comprising:
causing a video entertainment communication to display with a first advertisement at a first location; and
causing the video entertainment communication to display with a second advertisement at a second location;
where the first advertisement is caused to display at the first location concurrently with the second advertisement being caused to display at the second location,
where the first advertisement is integrated into a dynamic substance portion of the video entertainment communication when displayed, and
where the second advertisement is integrated into the dynamic substance portion of the video entertainment communication.

13. The non-transitory computer-readable medium of claim 12, where the first location is remote from the second location, and where the first advertisement and the second advertisements are different advertisements.

14. The non-transitory computer-readable medium of claim 12, where the first location is local to the second location, where the first location and the second location are different locations, and where the first advertisement and the second advertisements are different advertisements.

15. The non-transitory computer-readable medium of claim 12, the method comprising:
evaluating a viewing history for the first location to produce a first location viewing history result;
selecting the first advertisement based, at least in part, on the first location viewing history result;
evaluating a viewing history for the second location to produce a second location viewing history result; and
selecting the second advertisement based, at least in part, on the second location viewing history result.

16. A non-transitory computer-readable medium storing instructions for implementing:
a first device component to cause a first entertainment communication with a first advertisement to display on a first device; and
a second device component to cause a second entertainment communication with a second advertisement to display on a second device,
wherein the first device is associated with a user,
wherein the second device is associated with the user,
wherein the first advertisement and the second advertisement are unified in theme, and
wherein a processor executes at least a portion of the instructions related to the first device component or the second device component.

17. The non-transitory computer-readable medium claim 16, where the first advertisement and second advertisement are part of an advertisement strategy for the user, where the first device and second device are different devices, and where the first advertisement and the second advertisements are different advertisements.

18. The non-transitory computer readable medium of claim 17, the non-transitory computer-readable medium storing instructions for implementing:
a choice component to make a selection for the first advertisement and the second advertisement, where the selection is based, at least in part, on the advertisement strategy for the user.

19. The non-transitory computer readable medium of claim 18, the non-transitory computer-readable medium storing instructions for implementing:
a first device evaluation component to evaluate the first device to produce a first device evaluation result;
a second device evaluation component to evaluate the second device to produce a second device evaluation result; and
a construction component to create the advertisement strategy based, at least in part, on the first device evaluation result and the second device evaluation result.

20. The non-transitory computer readable medium of claim 16, the non-transitory computer-readable medium storing instructions for implementing:
a first advertisement evaluation component to evaluate the first advertisement to produce a first advertisement evaluation result;
an advertisement selection component to make a selection for the second advertisement, based, at least in part, on the first advertisement evaluation result; and
a second device selection component to select the second device based, at least in part, on the first advertisement evaluation result.
